(19) United States
(12) Patent Application Publication
(10) Pub. No.: US 2006/0156345 A1
(43) Pub. Date: Jul. 13, 2006

(54) Digital television apparatus

(75) Inventor: Takashi Ozawa, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/312,767

(22) Filed: Dec. 21, 2005

(30) Foreign Application Priority Data
Jan. 12, 2005 (JP) 2005-005080

(51) Int. Cl. H04N 5/445; G06F 3/00; G06F 13/00

(52) U.S. Cl. 725/58; 725/39; 725/44; 725/47

(57) ABSTRACT

This invention provides a digital television apparatus adapted to exclude channels of broadcast programs, in which the viewer has no interest, from an EPG display and improve EPG usability by providing short scroll capability through the EPG. The digital television apparatus includes a display device, an operating unit by which operating signals for various commands are input, a preset information storage in which channel skip information for channels is set, and an EPG information processing unit which, when the operating unit is operated to display an EPG, on the basis of an operating signal from the operation unit, selects channels which are set not to be skipped in the preset information storage and causes the display unit to display the EPG for the selected channels. The apparatus displays an EPG for only channels set not to be skipped on the display device.

The entire disclosure of Japanese Patent Application No. 2005-005080, filed Jan. 12, 2005, is expressly incorporated by reference herein.

### BACKGROUND OF THE INVENTION

1. Field of the Invention

The present invention relates to a digital television apparatus and, more particularly, to displaying an electronic program guide thereon.

2. Description of the Related Art

Recently, various types of television broadcasting, such as BS digital, CS digital, terrestrial digital, and terrestrial analog broadcasting, capable of providing numerous channels, have become available. In most cases, users have to subscribe to channels they want to view. When a user displays an Electronic Program Guide (EPG), a list of all broadcasting channels that the user can receive is usually displayed. If the list contains numerous channels, the list has to be scrolled. In some situations, the displayed list may include pay channels to which the user does not subscribe, in other words, channels that the user may not actually view. As a result, a problem of a long scroll through the EPG list has been occurring. To address this problem, for example, a method to exclude channels to which the user does not subscribe from an EPG display has been disclosed (e.g., see Japanese Unexamined Patent Application Publication No. 2002-252817). Since this method inhibits the display of the channels to which the user does not subscribe, that is, the channels that the user will not view, it takes just a short scroll to find a desired channel in the EPG.

However, users will not always view all channels to which they subscribe. Usually, users subscribe to a block of channels (channel package subscription) rather than individual channels (single channel subscription). This may result in that some of the subscribed broadcast program channels do not match the viewer's preference. In view thereof, a problem with the above known art method (the aforementioned publication) is that the method cannot inhibit the display of channels that the user will not view, because it only determines whether to include a channel in an EPG display simply depending on whether the channel is one to which the user subscribes.

### SUMMARY

The present invention is intended to solve the above problem. Accordingly, it is an object of the present invention to provide a digital television apparatus adapted to exclude channels of broadcast programs in which the viewer has no interest from an EPG display and improve EPG usability by providing a short scroll capability through the EPG.

In one aspect of the present invention, a digital television apparatus includes a display device, an operating unit by which operating signals for various commands are input, a preset information storage in which channel skip information for channels is set, and an EPG information processing unit which, when the operating unit is operated to display an EPG, based on an operating signal from the operation unit, selects channels which are set not to be skipped in the preset information storage and makes the display unit display the EPG for the selected channels. The digital television apparatus of the present invention displays an EPG for only channels set not to be skipped on the display device. For example, by setting channels, in which the viewer has no interest to be skipped in the preset information storage, the apparatus skips those channels and displays an EPG for the channels matching the viewer's interest. Therefore, the apparatus has an advantage in which the viewer can look through an EPG with a little scroll.

In another aspect of the invention, the digital television apparatus may include a tuner which performs received signal tuning and related processing. The EPG information processing unit may take in EPG information from the tuner and make the display unit display the EPG.

In yet another aspect of the invention, in the digital television apparatus, the EPG information processing unit may generate an EPG for a predetermined number of channels including a channel, a program on which is now displayed on the display device. Thus, the viewer can check out the EPG for channels adjacent to the channel, a program on which is now displayed.

In yet another aspect of the invention, in the digital television apparatus, when an EPG for a predetermined number of channels is displayed on the display device and the operating unit is operated to scroll the EPG, the EPG information processing unit may select channels set not to be skipped in the preset information storage in accordance with an operating signal from the operating unit, and make the display device display an EPG for the selected channel. In this aspect of the invention, an EPG can be scrolled by scroll control on the operating unit. During the scroll, channels in which the viewer has no interest are excluded from the EPG display, and consequently, scrolling can be finished in a shorter time.

In a further aspect of the invention, in the digital television apparatus, the EPG information processing unit may make the display device display an EPG in a manner to be superposed on a program of a channel being displayed on the display device. Because an EPG is superimposed on a program being displayed, the viewer can check out the contents of the EPG, while viewing the program being provided on the currently receiving channel.

In a still further aspect of the invention, the digital television apparatus may further include a setting operation unit which, when the operating unit is operated to set channel skip information, makes the display device display the skip information entered from the operating unit and sets the skip information into the preset information storage. In this aspect of the invention, because the setting operation unit makes the display device display a skip information entered from the operating unit and sets the skip information into the preset information storage, the viewer can easily set desired skip setting for the viewer.

In a still further aspect of the invention, the digital television apparatus may further include a channel selection unit which, when the operating unit is operated to shift up or down for selecting a channel, selects a channel set not to be skipped in the preset information storage in accordance with an up or down operating signal from the operating unit, instructs the tuner to tune to the selected channel, and makes the display device display a program provided on the channel. In this aspect of the invention, because the channel selection unit skips a channel or channels set to be skipped and selects a channel set not to be skipped, the apparatus provides enhanced usability for the viewer.

### BRIEF DESCRIPTION OF THE DRAWINGS

FIG. 1 is a block diagram showing a configuration of a digital television apparatus according to an embodiment of the present invention;

FIG. 2 is a front view of a remote controller;

FIG. 3 illustrates an example of a preset information table stored in preset information storage;

FIG. 4 is a flowchart illustrating processing by means of an EPG information processing unit;

FIG. 5A shows an example of EPG display to be shown on one screen according to the present invention and FIG. 5B shows a reference example of the corresponding EPG display of the known art;

FIG. 6 is a flowchart illustrating another processing by means of the EPG information processing unit;

FIG. 7 illustrates how an EPG is displayed according to processing in the flowchart of FIG. 6;

FIG. 8 is a flowchart illustrating processing by means of a channel selection unit; and

FIG. 9 illustrates a relationship between up/down button actuation and channel selection.

### DESCRIPTION OF THE PREFERRED EMBODIMENTS

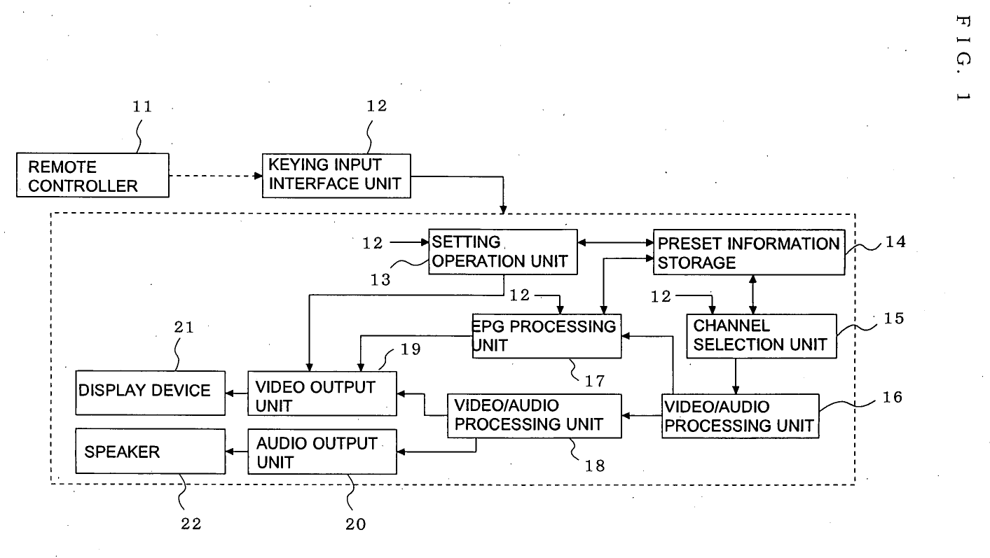

FIG. 1 is a block diagram showing a configuration of a digital television apparatus according to an embodiment of the present invention. This digital television apparatus is composed of a remote controller 11, a keying input interface unit 12, a setting operation unit 13, a preset information storage unit 14, a channel selection unit 15, a tuner 16, an EPG information processing unit 17, an audio/video processing unit 18, a video output unit 19, an audio output unit 20, a display device 21, and a speaker 22, as is shown in FIG. 1. The remote controller 11 is equipped with buttons (keys) for specific functions which are operated by the viewer, including channel selection buttons (numeric buttons which are used for directly entering a channel number and up and down buttons for selecting a channel) and an EPG button which is used to display an EPG (see FIG. 2 which will be discussed later). An operating signal input by the remote controller 11 is processed at the keying input interface unit 12 and a control signal (command) corresponding to the operating signal is output. When an operating signal to activate channel skip setting is input by the remote controller 11, the setting operation unit 13, receives the command corresponding to the operating signal from the keying input interface unit 12, and instructs the video output unit 19 to display a setting screen. When the viewer sets a channel to be skipped on the setting screen by operating the remote controller 11, the setting operation unit 13 receives the setting via the keying input interface unit 12 and stores it into the preset information storage unit 14.

When the viewer specifies a channel which the viewer wants to view by operating the remote controller 11, the channel selection unit 15 receives the channel selection via the keying input interface unit 12 and outputs a channel selection signal to the tuner 16. The tuner 16 tunes to the channel corresponding to the channel selection signal. The tuner 16 is connected to an antenna (not shown), for example, and the antenna is equipped with a frequency converter. The antenna receives, for example, digital broadcast signals transmitted from a communication satellite (CS) and outputs these signals with converted frequency to the tuner. The tuner 16 includes a demodulator, a deinterleaver, an error correction circuit, and so on and carries out processing to extract specific frequency signals from among radio-frequency digital modulated signals containing audio and video data. In other words, the tuner selects one of a plurality of transponders of digital broadcasting. The audio/video processing unit 18 includes a demultiplexer, a video decoder, an audio decoder, and so on, whereby the demultiplexer separates the received transport stream into a video stream, for example, conforming to Moving Picture Experts Group 2 (MPEG2) and an audio stream. The video stream is processed by the video decoder, that is, input variable-length codes are decoded and a quantization factor and a motion vector are determined. The video data, after being subjected to Inverse Discrete Cosine Transform (IDCT) and motion vector compensation on the basis of the motion vector, is output to the video output unit 19. The video output unit 19 generates video signals to be displayed on the display device 21 from the video signal from the audio/video processing unit 18. The video output unit 19 includes, for example, a scaler/on-screen display (OSD) processing circuit, a frame memory, and so on. For example, image data is generated per frame and stored into the frame memory, and the frame image data (video signals) is read and then D/A converted into, for example, composite video signals which are output to the display device 21. The display device 21 displays a TV picture or the like corresponding to the video signals.

In the audio/video processing unit 18, the video decoder also decodes input coded signals of the audio stream into audio signals (audio data) which are output to the audio output unit 20. The audio output unit 20 D/A converts the audio signals into analog signals which are, for example, separated into right-hand (R) sound and left-hand (L) sound. The analog sound signals are amplified and output to the speaker 22 and sound is produced from the speaker 22.

When the viewer inputs an operating signal to display an EPG by operating the remote controller 11, the EPG information processing unit 17 receives a command corresponding to the operating signal via the keying input interface unit 12, extracts EPG-related information within program specific information/service information (PSI/SI) from the transport stream output from the tuner 16, and outputs that information to the video output unit 19. The EPG related information may be obtained from the demultiplexer of the audio/video processing unit 18. The video output unit 19 generates video signals for the EPG in such a way as to be superposed on an image displayed on the display device 21, using the OSD processing circuit provided therein, and causes the display device 21 display the superimposed EPG.

In the manner as described above, upon a channel selection made by the viewer operating the remote controller 11, the channel selection signal is sent via the keying input interface unit 12 and the channel selection unit 15 to the tuner 16. A transponder for the selected channel is selected by the tuner 16 and broadcast signals received by the transponder are sent to the audio/video processing unit 18 from which video signals thereof are sent to the video output unit 19 and audio signals thereof are sent to the audio output unit 20. The audio output unit 19 performs the above-mentioned signal processing on the video signals and causes the display device 21 to display the video on the channel. The audio output unit 20 causes the speaker to output the audio on the channel.

FIG. 2 is a front view of the remote controller 11. The remote controller 11 is equipped with buttons for several functions such as numeric buttons (numeric keys) 11a which are used for directly entering a channel number, up and down buttons 11b for selecting a channel, an EPG button 11c, and shift buttons 11d. The keying input interface unit 12 receives in an operating signal from the remote controller 11 and outputs a command corresponding to the operating signal to, for example, the setting operation unit 13, the EPG information processing unit 17, and the channel selection unit 15.

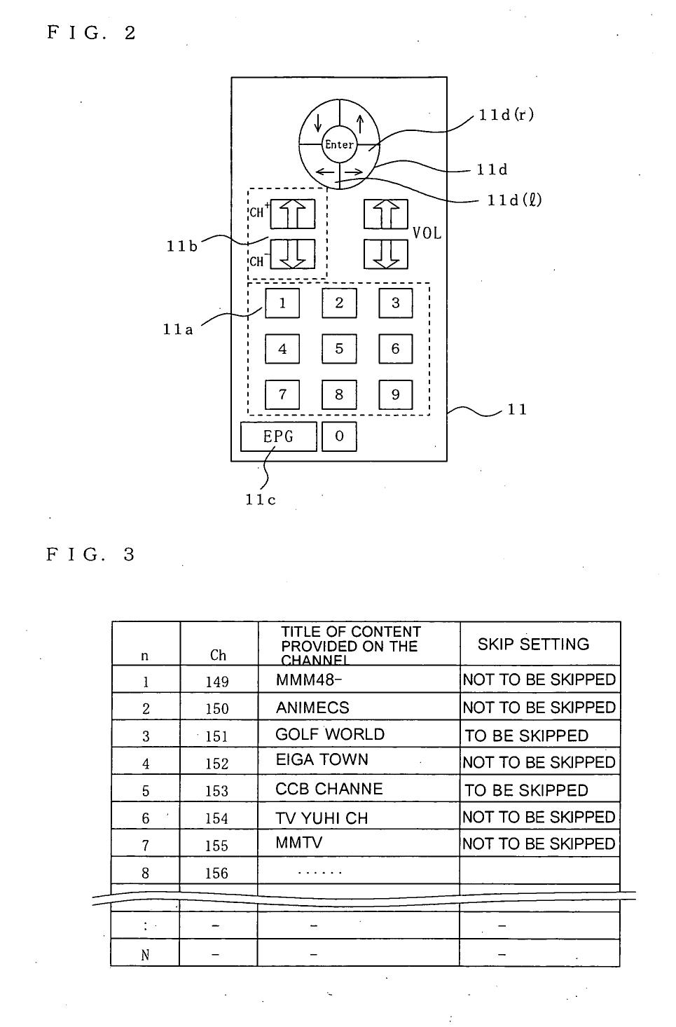

FIG. 3 illustrates an example of a preset information table stored in the preset information storage 14. This table is made up of the following columns: channel number, name of broadcasting, and skip setting. Each channel is set “to be skipped” or “not to be skipped.” For this setting, the setting operation unit 13 acquires the relevant operating signal input from the remote controller 11 via the keying input interface unit 12 and outputs the command to display an input screen for skip setting to the video output unit 19. The video output unit 19 causes the display device 21 to display the setting screen. In a way of displaying the setting screen, for example, the preset information table shown in FIG. 3 retrieved from the preset information storage 14 is displayed in the screen. In the skip setting column of the table displayed on the display device 21, the viewer is allowed to set a setting to “not to be skip” or “to be skipped” for each title by using, for example, the shift buttons 11d. It is preferable to initially default the skip setting to, for example, “not to be skipped” in the preset information table stored in the preset information storage unit 14 and, subsequently, the setting can be changed according to the viewer's preference. In the table of FIG. 3, the channels are assumed to have serial address numbers n in the range of 1 to N for convenience.

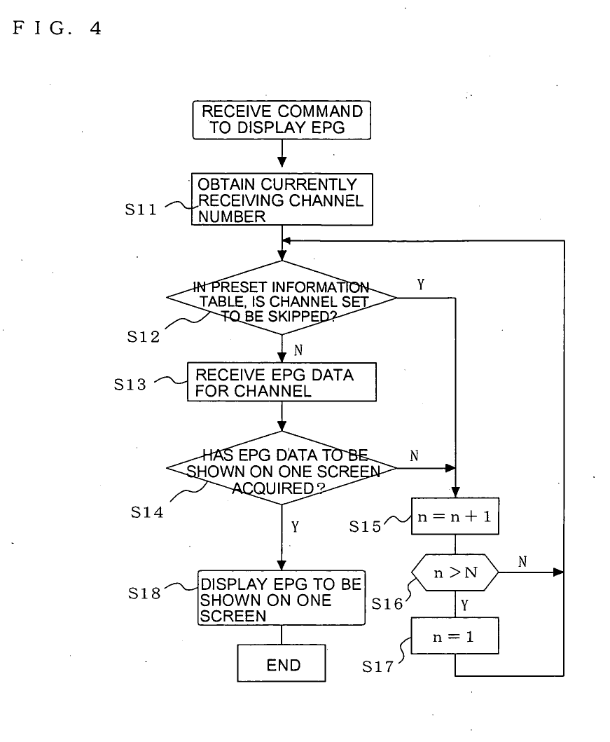

FIG. 4 is a flowchart illustrating processing by means of the EPG information processing unit 17, triggered by depressing the EPG button 11c on the remote controller 11, when a program on a TV broadcast channel is displayed on the display device, after the viewer selects the channel by using, for example, the numeric buttons 11a on the remote controller 11.

The EPG information processing unit 17 obtains the currently received channel number from the tuner 16 (S11) and checks to see whether the channel is set to be skipped (S12) by referring to the preset information table (see FIG. 3) set up in the preset information storage unit 14. If the channel is set not to be skipped, the EPG information processing unit 17 receives EPG data for the channel from the tuner 16 (S13). Next, the EPG information processing unit 17 determines whether EPG data to be shown on one screen has been acquired (S14). If, for example, it is set to display information about the programs on four channels on one screen, when the EPG data for four channels has been acquired, it is determined that EPG data to be shown on one screen has been acquired. Now the EPG data for only one channel has been acquired, and the next channel will be selected. Here, given that the address number of the currently selected channel is n, the address number is incremented by one, n=n+1 (S15). It is determined whether the address number n exceeds the total number of channels N (S16). If the address number n does not exceed the total number of channels N, the channel having the incremented address number n is selected. If the address number n exceeds the total number of channels N, n is reset to 1 (n=1) and the first channel listed in the preset information table is selected (S17). If an EPG for the predetermined number of channels even including the last channel listed in the preset information table cannot be displayed, EPG data is handled so as to be displayed together with the EPG for the first and subsequent channels listed in the table.

Then, the above step S12 and subsequent steps are repeated. By referring to the preset information table set up in the preset information storage unit 14, if knowing that the selected channel is set to be skipped, the EPG information processing unit 17 does not acquire the EPG data for the channel and selects the next channel (S15 to S17). If the selected channel is set not to be skipped, the EPG information processing unit 17 receives the EPG data for the channel (S13). When having acquired the EPG data to be shown on one screen, the EPG information processing unit 17 outputs that EPG data to the video output unit which in turn causes the display device to display the EPG to be shown on one screen (S18).

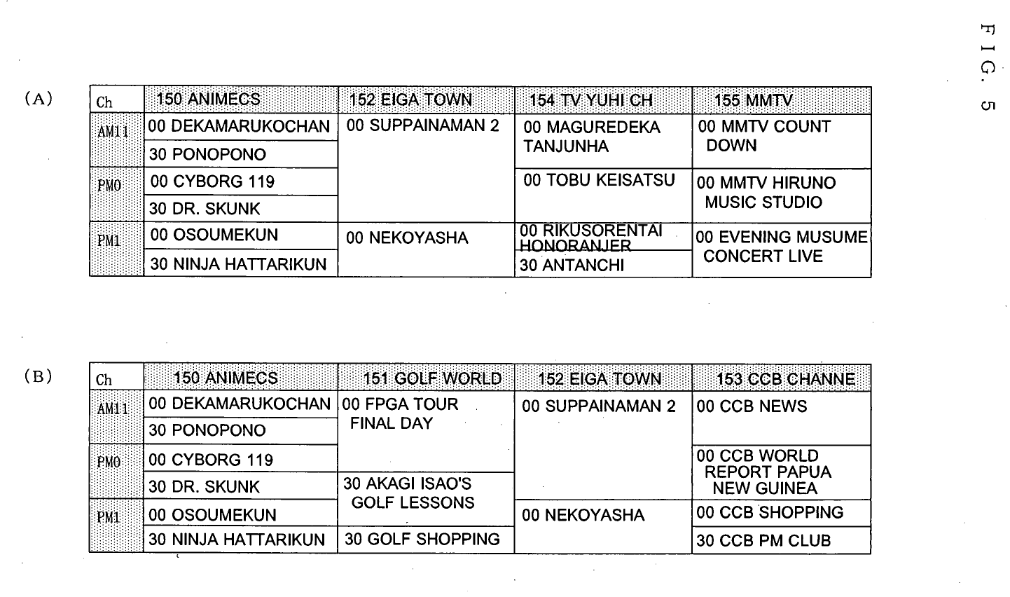

FIG. 5A shows an example of EPG display to be shown on one full screen. Since channels 151 and 153 are set to be skipped in the preset information table of FIG. 3, EPG for these channels is not shown. In this example, EPG for channels 150, 152, 154, and 155 is shown.

FIG. 5B shows a reference example of the corresponding EPG display in the known art, whereby EPG for channels to be shown on one screen without skip setting is displayed. EPG for four channels in ascending order from the lowest channel number in the preset information table of FIG. 3 is displayed.

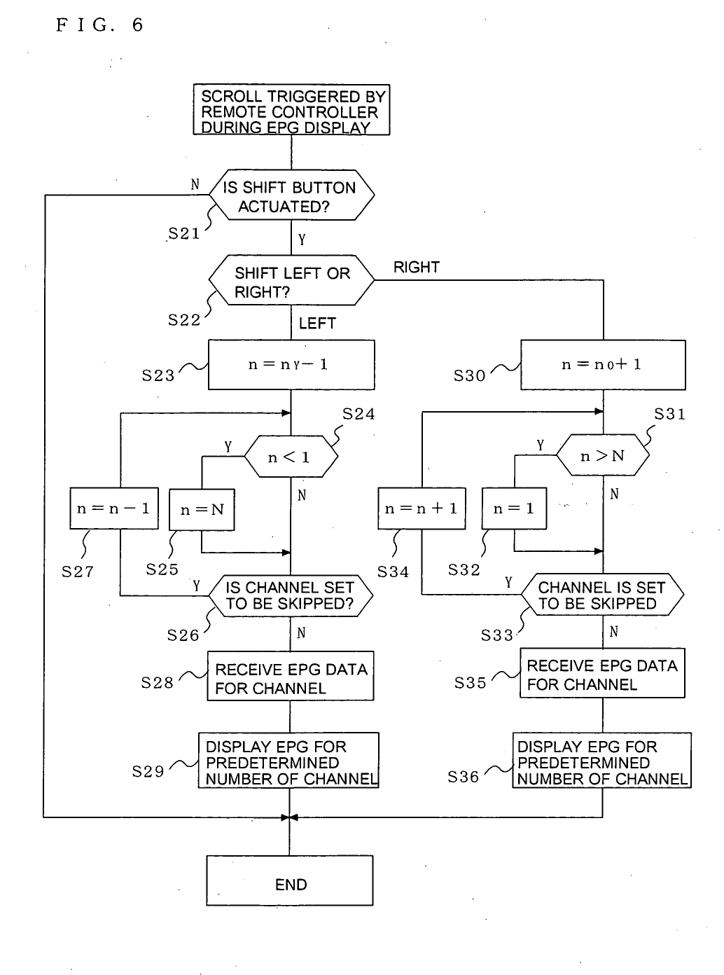

FIG. 6 is a flowchart of processing by means of the EPG information processing unit 17 when the channels in the displayed EPG shown in FIG. 5A are scrolled.

The EPG information processing unit 17 detects whether a button on the remote controller 11 is depressed (S21). If no button is depressed, the process terminates. At this time, the button that is depressed on the remote controller 11 may be either of the up and down buttons 11d for selecting a channel or the shift buttons 11d. Here, a case where one of the shift buttons 11d is depressed is discussed. The EPG information processing unit 17 detects whether a left shift button 11d (l) or a right shift button 11d (r) of the shift buttons 11d is depressed (S22). When the left shift button 11d (l) is depressed, the EPG information processing unit 17 specifies a channel n with the lowest address number ny in the currently displayed EPG and decrements n by one, n=ny−1 (S23). Then, it determines if n is less than 1 (S24). If n is less than 1, that is, n falls outside the preset information table, n is reset to N, n=N (S24). If n is not less than 1, the value of n is maintained and the EPG information processing unit 17 checks to see whether the channel with the address number n is set to be skipped (S26). If the channel is set to be skipped, the EPG information processing unit 17 decrements n by one, n=n−1 (S27) and repeats the above steps (S24 to S26). If the channel is set not to be skipped, the EPG information processing unit 17 receives the EPG data for the channel with the address number n from the tuner 16 (S28) and causes the display device 21 to display the EPG for the predetermined number of channels including that channel (S29). As a consequence, a channel with the largest address number in the previously displayed EPG is removed and the EPG display shifts to the smaller address channels.

When the right shift button 11d (r) is depressed, the EPG information processing unit 17 specifies a channel n with the largest address number n in the currently displayed EPG and increments n by one, n=nₒ+1 (S30). Then, it determines if n is more than N (S31). If n is more than N, that is, n falls outside the preset information table, n is reset to 1, n=1 (S32). If n is not more than N, the value of n is maintained, and the EPG information processing unit 17 checks to see whether the channel with the address number n is set to be skipped (S33). If the channel is set to be skipped, the EPG information processing unit 17 increments n by one, n=n+1 (S34) and repeats the above steps (S31 to S33). If the channel is set not to be skipped, the EPG information processing unit 17 receives the EPG data for the channel with the address number n from the tuner 16 (S35) and causes the display device 21 to display the EPG for the predetermined number of channels including that channel (S36). As a consequence, a channel with the smallest address number in the previously displayed EPG is removed and the EPG display shifts to the larger address channels.

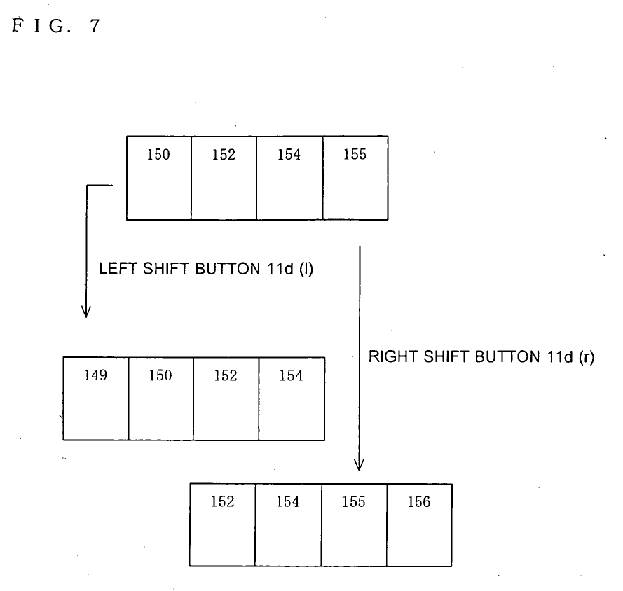

FIG. 7 illustrates how an EPG is displayed according to processing shown in the flowchart of FIG. 6. For example, during the display of EPG for channels 150, 152, 154, and 155, as shown in FIG. 5A, when the left shift button 11d (l) is depressed, the EPG for channels 149, 150, 152, and 154 is displayed and the EPG for channel 155 disappears. When the right shift button 11d is depressed, the EPG for channels 152, 154, 155, and 156 is displayed and the EPG for channel 150 disappears.

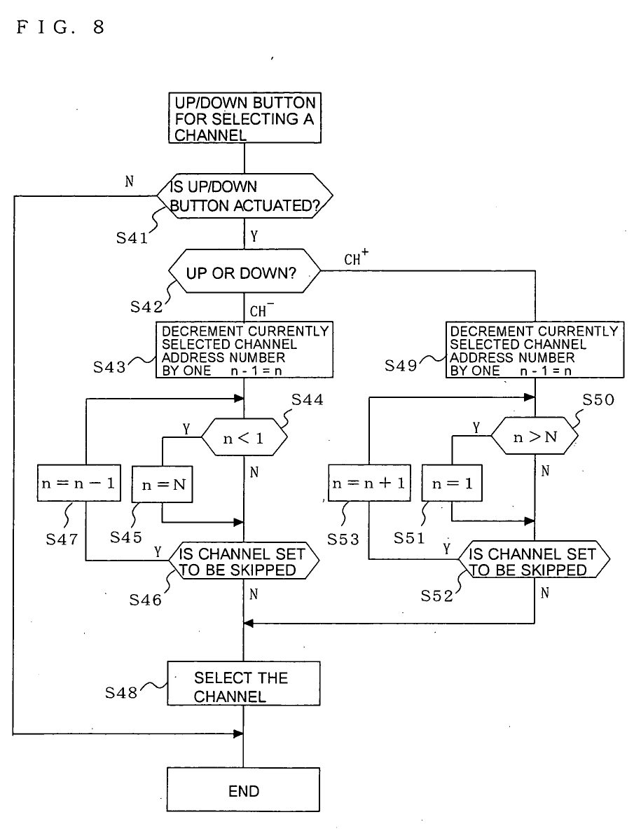

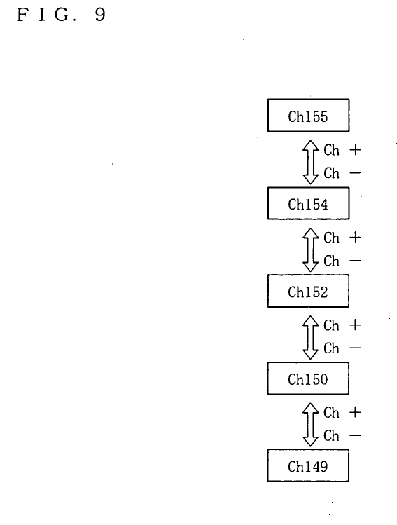

FIG. 8 is a flowchart illustrating processing by means of the channel selection unit 15 when changing one channel to another by depressing one of the up and down buttons 11b for selecting a channel on the remote controller 11. FIG. 9 illustrates a relationship between up/down button actuation and channel selection.

The channel selection unit 15 detects whether one of the up and down buttons 11b for selecting a channel on the remote controller 11 is depressed (S41) and, if so, detects whether the down button (CH−) or up button (CH+) is depressed (S41). When the down button 11b (CH−) is depressed, the channel selection unit 15 decrements the currently selected channel address number by one, n−1=n (S43) and determines if n is less than 1 (S44). If n is less than 1, that is, n falls outside the preset information table, n is reset to N; as a result, address n=N follows address n=1 (S45). After steps S44 and S45, the channel selection unit 15 checks to see whether the channel with the address number n is set to be skipped by referring to the preset information table in the preset information storage unit 14 (S46). If the channel is set to be skipped, the channel selection unit 15 decrements the address number by one again, n−1=n (S47) and repeats the above steps. If the channel is set not to be skipped, the channel selection unit 15 selects that channel (S48). In FIG. 9, for example, when a channel 152 has been selected, upon depressing of the down button (CH−), the channel selection unit 15 selects a channel 150 through the execution of the above steps. When the down button (CH−) is depressed again, the channel selection unit 15 selects a channel 149 through the execution of the above steps.

If the up button 11b (CH+) is depressed, as detected at step S42, the channel selection unit 15 increments the currently selected channel address number by one, n+1=n (S49) and determines if n is more than N (S50). If n is more than N, that is, n falls outside the preset information table, n is reset to 1 (S51); as a result, address n=1 follows address n=N. After steps S50 and S51, the channel selection unit 15 checks to see whether the channel with the address number n is set to be skipped by referring to the preset information table in the preset information storage 14 (S52). If the channel is set to be skipped, the channel selection unit 15 increments the address number by one again, n+1=n (S53) and repeats the above steps S50 and S51. If the channel is set not to be skipped, the channel selection unit 15 selects that channel and instructs the tuner 16 to tune to it (S48). In FIG. 9, for example, when a channel 152 has been selected, upon depressing of the up button (CH+), the channel selection unit 15 selects a channel 154, skipping a channel 153, through the execution of the above steps. When the up button (CH+) is depressed again, the channel selection unit 15 selects a channel 155 through the execution of the above steps.

As described above, in the present embodiment, only those channels that are set not to be skipped are listed in an EPG display. By setting channels of broadcast programs, for example, channels in which the viewer has no interest, to be skipped in the preset information storage, the digital television apparatus skips those channels and displays an EPG for the channels matching the viewer's interest. Therefore, the viewer can navigate through an EPG with a short scroll. The EPG information processing unit 17 may cause the display device 21 to display an EPG for a predetermined number of channels including a channel, on which a program is now displayed on the display device 21. Therefore, the viewer can check out content of the EPG for channels adjacent to the channel on which a program is now displayed (currently received channel). When an EPG for channels is displayed on the display device 21 and the remote controller 11 is operated to scroll the EPG, the EPG information processing unit 17 may select a channel set not to be skipped in the preset information storage unit 14 in accordance with an operating signal from the remote controller 11 and cause the display device 21 to display the EPG including the selected channel. In this way, by operating the remote controller 11, the EPG can be scrolled. At this time, channels in which the viewer has no interest are excluded from the EPG display and the viewer can navigate through the EPG with a short scroll.

The EPG information processing unit 17 may cause the display device 21 to display an EPG in a manner to be superposed on a program on a channel being displayed on the display device 21. The viewer can check out the content of the EPG, while viewing the program being provided on the currently received channel. When the remote controller 11 is operated to set channel skip information, the setting operation unit 13 may cause the display device 12 to display an entry of the skip information entered from the remote controller 11 and set that information into the preset information storage 14. Thus, the viewer can easily set a desired skip setting.

When the remote controller 11 is operated to shift up or down for selecting a channel, the channel selection unit 15 may select a channel set not to be skipped in the preset information storage unit 14, according to the up or down operating signal, and instruct the tuner 16 to tune to the selected channel. By selecting a channel set not to be skipped, skipping a channel or channels set to be skipped, the digital television apparatus provides enhanced usability for the viewer.

While the remote controller is used as an example of operating means in the above-described embodiment, keys or buttons installed on the mainframe of the digital television apparatus may be used instead of or in conjunction with the remote controller. While, in the above embodiment, an example where an EPG covering four channels is displayed has been discussed, the number of those channels may be arbitrary and may be set according to the screen size of the display device. Furthermore, the digital television apparatus according to the present invention is not intended to supersede traditional functions and may preferably be provided with the functions illustrated by the foregoing embodiment in addition to the traditional functions.

1. A digital television apparatus comprising:
a display device;
an operating unit with which operating signals for various commands are input;
a preset information storage unit in which channel skip information is set; and
an electronic program guide (EPG) information processing unit which, when said operating unit is operated to display an EPG, on the basis of an operating signal from said operation unit, selects channels which are set not to be skipped in said preset information storage unit and causes said display unit to display the EPG for the selected channels.

2. The digital television apparatus according to claim 1, further comprising:
a tuner which performs received signal tuning and related processing,
wherein said EPG information processing unit acquires EPG information from said tuner and causes said display unit to display the EPG

3. The digital television apparatus according to claim 1, wherein said EPG information processing unit causes said display device to display an EPG for a predetermined number of channels including a channel, a program on which is now displayed on said display device.

4. The digital television apparatus according to claim 3, wherein when an EPG for a predetermined number of channels is displayed on said display device and said operating unit is operated to scroll the EPG, said EPG information processing unit selects a channel not set to be skipped in said preset information storage unit in accordance with an operating signal from said operating unit and causes said display device to display an EPG for channels including the selected channel upon scrolling operation of said operating unit.

5. The digital television apparatus according to claim 1, wherein said EPG information processing unit causes said display device to display an EPG in a manner to be superposed on a program on a channel being displayed on said display device.

6. The digital television apparatus according to claim 1, further comprising:
a setting operation unit which, when said operating unit is operated to set channel skip information, causes said display device to display the channel skip information entered from said operating unit and sets the skip information into said preset information storage unit.

7. The digital television apparatus according to claim 2, further comprising:
a channel selection unit which, when said operating unit is operated to shift up or down for selecting a channel, selects a channel set not to be skipped in said preset information storage unit in accordance with an up or down operating signal from said operating unit, instructs said tuner to tune to the selected channel, and causes said display device to display a program on the selected channel.

8. The digital television apparatus according to claim 2, wherein said EPG information processing unit causes said display device to display an EPG for a predetermined number of channels including a channel, a program on which is now displayed on said display device.

9. The digital television apparatus according to claim 2, wherein said EPG information processing unit causes said display device to display an EPG in a manner to be superposed on a program on a channel being displayed on said display device.

10. The digital television apparatus according to claim 3, wherein said EPG information processing unit causes said display device to display an EPG in a manner to be superposed on a program on a channel being displayed on said display device.

11. The digital television apparatus according to claim 4, wherein said EPG information processing unit causes said display device to display an EPG in a manner to be superposed on a program on a channel being displayed on said display device.

12. The digital television apparatus according to claim 2, further comprising:
a setting operation unit which, when said operating unit is operated to set channel skip information, causes said display device to display the channel skip information entered from said operating unit and sets the skip information into said preset information storage unit.

13. The digital television apparatus according to claim 3, further comprising:
a setting operation unit which, when said operating unit is operated to set channel skip information, causes said display device to display the channel skip information entered from said operating unit and sets the skip information into said preset information storage unit.

14. The digital television apparatus according to claim 4, further comprising:
a setting operation unit which, when said operating unit is operated to set channel skip information, causes said display device to display the channel skip information entered from said operating unit and sets the skip information into said preset information storage unit.

15. The digital television apparatus according to claim 5, further comprising:
a setting operation unit which, when said operating unit is operated to set channel skip information, causes said display device to display the channel skip information entered from said operating unit and sets the skip information into said preset information storage unit.

16. The digital television apparatus according to claim 3, further comprising:
a channel selection unit which, when said operating unit is operated to shift up or down for selecting a channel, selects a channel set not to be skipped in said preset information storage unit in accordance with an up or down operating signal from said operating unit, instructs said tuner to tune to the selected channel, and causes said display device to display a program on the selected channel.

17. The digital television apparatus according to claim 4, further comprising:
a channel selection unit which, when said operating unit is operated to shift up or down for selecting a channel, selects a channel set not to be skipped in said preset information storage unit in accordance with an up or down operating signal from said operating unit, instructs said tuner to tune to the selected channel, and causes said display device to display a program on the selected channel.

18. The digital television apparatus according to claim 5, further comprising:
a channel selection unit which, when said operating unit is operated to shift up or down for selecting a channel, selects a channel set not to be skipped in said preset information storage unit in accordance with an up or down operating signal from said operating unit, instructs said tuner to tune to the selected channel, and causes said display device to display a program on the selected channel.

19. The digital television apparatus according to claim 6, further comprising:
a channel selection unit which, when said operating unit is operated to shift up or down for selecting a channel, selects a channel set not to be skipped in said preset information storage unit in accordance with an up or down operating signal from said operating unit, instructs said tuner to tune to the selected channel, and causes said display device to display a program on the selected channel.
